(19) United States
(12) Patent Application Publication
(10) Pub. No.: US 2026/0299632 A1
(43) Pub. Date: Oct. 1, 2026

(54) VEHICLE PEDAL ASSEMBLY INCLUDING A FRICTION DEVICE

(71) Applicant: CTS CORPORATION, Lisle, IL (US)

(72) Inventors: John Clark, Granger, IN (US); Alfredo Rodriguez, Elkhart, IN (US)

(21) Appl. No.: 19/630,174

(22) Filed: Mar. 26, 2026

Related U.S. Application Data
(60) Provisional application No. 63/778,163, filed on Mar. 26, 2025.

(51) Int. Cl. G05G 5/03; G05G 1/38; G05G 1/44; G05G 1/46

(52) U.S. Cl. CPC G05G 5/03; G05G 1/38; G05G 1/44; G05G 1/46; G05G 2700/14

(57) ABSTRACT

A pedal assembly for a vehicle may include a pedal arm, a pedal base, a rotor in communication with the pedal arm, the rotor rotating in response to movement of the pedal arm. The pedal assembly may include a force emulator in communication at a first end with the pedal arm and a lever joined at a first end to the rotor and joined at a second end to a second end of the force emulator. The pedal assembly may include a friction device mounted to the lever with a friction surface for contacting a contact portion of the pedal base. Rotation of the rotor occurs due to application of force to the pedal arm which moves the lever.

This present disclosure relates to a vehicle pedal assembly and, more specifically, to structures and systems, including a friction device.

### BACKGROUND

A traditional vehicle pedal system for automatic transmission vehicles includes an accelerator pedal and a brake pedal. Each pedal included in the system is attached to a metal or composite plastic arm, which in turn is connected to a hinge in such a way that when the user (driver) presses the pedal, the pedal moves, usually several inches over full range, to affect a response in the vehicle. In the case of an accelerator pedal, the vehicle in drive moves forward and accelerates gradually or quickly, depending on the throttle demand, which is solely a function of the position of the pedal in relation to the origin (as a result of the driver's exerted force). Conversely, when the driver desires to slow a vehicle that is in motion, the driver presses the brake pedal to slow the car. The rate at which the car slows is determined by the position of brake pedal in relation to its origin. The amount of time-typically tens to hundreds of milliseconds-between the time that the driver initially applies a force to a pedal and the time that the brake/accelerator pedal module (APM) controller confidently identifies the user demand is defined as the latency. This latency (measured in time) is a function of the underlying displacement resolution of the sensor (its ability to confidently resolve purposeful displacement from the absence of purposeful displacement).

In addition, some traditional vehicle pedal systems deploy purposeful hysteresis control schemes, which permit the driver to modulate the force of their demand, within bounds, to maintain the same throttle output, thereby reducing driver fatigue. Such vehicle pedal systems incorporate cooperating and engageable frictional members to generate a desired mechanical hysteresis effect in response to movement of the vehicle pedal. Examples of such vehicle pedal systems are disclosed in U.S. Pat. Nos. 7,926,384; 8,042,430; and 8,806,977, which are assigned to CTS Corporation. Mechanical hysteresis systems are not particularly suited or applicable for use with low displacement vehicle pedals, which operate in response to no or little movement of the pedal. Examples of such low displacement vehicle pedals are disclosed in U.S. Pat. No. 10,175,712, which is assigned to CTS Corporation.

### SUMMARY

Aspects of the present disclosure are directed to systems and methods for a vehicle pedal that includes a friction device.

One aspect is directed to a pedal assembly for a vehicle comprising a pedal arm, a pedal base including a contact portion, a rotor coupled to the pedal arm, the rotor rotating in response to movement of the pedal arm. The pedal assembly includes a force emulator extending between a first end and a second end, the first end coupled to the pedal arm. The pedal arm includes a lever joined at a first end to the rotor and joined at a second end to the second end of the force emulator and a friction device mounted to the lever, the friction device including a friction surface configured to engage the contact portion for surface-to-surface contact, wherein rotation of the rotor due to application of a force to the pedal arm moves the lever.

Another aspect is directed to a pedal assembly for a vehicle comprising a pedal arm, a pedal base including a contact portion, a hinge coupling the pedal arm to the pedal base, a rotor in communication with the pedal arm, the rotor rotating in response to movement of the pedal arm. The pedal assembly includes a force emulator extending between a first end and a second end, the first end in communication with the pedal arm. The pedal assembly includes a lever joined at a first end to the rotor and joined at a second end to the second end of the force emulator and a friction device mounted to the lever, the friction device including a friction surface configured to engage the contact portion for surface-to-surface contact, wherein rotation of the rotor due to application of force to the pedal arm moves the lever.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate examples, instances, and/or aspects of concepts that include the claimed subject matter, and explain various principles and advantages of examples, instances, and/or aspects.

FIG. 1 is a cross-sectional view of a vehicle pedal assembly having a friction device in a relaxed position, according to one example.

FIG. 2 is a cross-sectional view of the vehicle pedal assembly of FIG. 1 in a force activated position, according to one example.

FIG. 3 is cross-sectional view of another vehicle pedal assembly in a disengaged or relaxed position, according to another example.

FIG. 4 illustrates a friction device for a vehicle pedal assembly according to one example.

FIG. 5 illustrates the friction device from FIG. 4 according to another viewpoint.

FIG. 6 illustrates a friction device for a vehicle pedal assembly according to another example.

FIG. 7 illustrates the friction device from FIG. 6 according to another viewpoint.

FIG. 8 illustrates a fifth friction device for a vehicle pedal assembly according to another example.

FIG. 9 illustrates a sixth friction device for a vehicle pedal assembly according to another example.

FIG. 10 illustrates a seventh friction device for a vehicle pedal assembly according to another example.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples.

The apparatus and method components have been represented where appropriate by conventional symbols in the drawings, showing only those specific details that are pertinent to understanding the examples, instances, and aspects illustrated so as not to obscure the disclosure with details that will be readily apparent to those of ordinary skill in the art having the benefit of the description herein.

### DETAILED DESCRIPTION

One or more aspects are described and illustrated in the following description and accompanying drawings. These aspects are not limited to the specific details provided herein and may be modified in various ways. Furthermore, other aspects may exist that are not described herein. For example, a device or structure that is “configured” in a certain way is configured in at least that way but may also be configured in ways that are not listed.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms, for example, first and second, top and bottom, and the like may be used herein solely to distinguish one entity or action from another entity or action without necessarily requiring or implying any actual such relationship or order between such entities or actions.

The pedal assemblies disclosed herein are included in and operatively connected to a vehicle (not shown). Each pedal assembly is adapted for use with systems and methods of the present disclosure for emulating a mechanical hysteresis effect in a vehicle pedal.

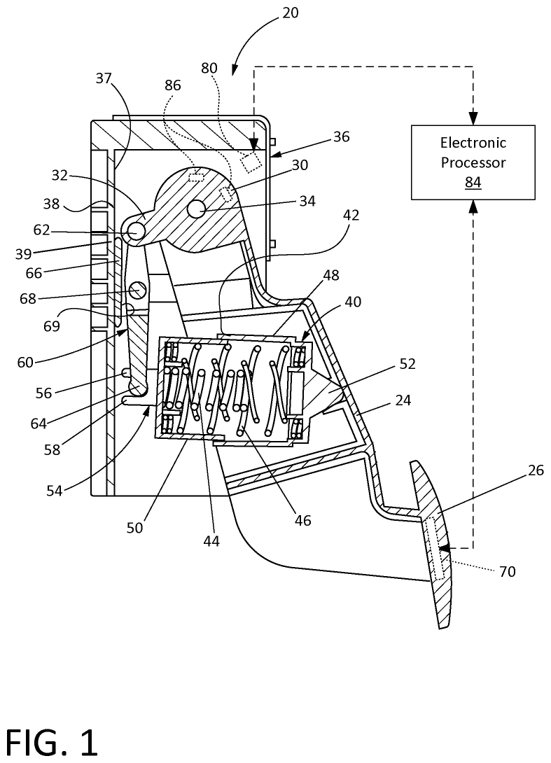

FIG. 1 illustrates a pedal assembly 20 according to one example. The pedal assembly 20 includes a pedal arm 24 that supports a pedal pad 26. The pedal arm 24 connects with a rotor 30 that rotates about an axis hub 34 during movement of the pedal arm 24. The rotor 30 includes a rotor projection 32 projecting away from the axis hub 34 and near an outer edge of the rotor. The pedal assembly 20 includes a pedal base 36 configured to receive the rotor 30 and pedal arm 24. The pedal base 36 may be formed as a housing having an inner wall 38 with a first surface 37 defining a contact portion 39 facing the pedal arm 24.

The pedal assembly 20 includes a force emulator 40. The force emulator 40 may include a housing 42 having a first spring 44 and a second spring 46 disposed therein. In one example the first spring 44 telescopes within the second spring 46. The housing 42 may include a first housing section 48 and a second housing section 50 that telescopes within the first housing section 48. The force emulator 40 may include a first end projection 52 shaped to contact the pedal arm 24 and extending from the first housing section 48. The force emulator 40 may include a second end projection 54 having a pair of spaced prongs 56, 58 extending from the second housing section 50 and configured to receive an element. While two springs 44, 46 are shown in the force emulator 40, additional springs, including three or more springs are contemplated for other examples. For instance, the springs can begin compressing at different amounts of movement of the second housing section 50 entering into the first housing section 48.

The pedal assembly 20 includes a lever 60 extending between a first end 62 coupled to the rotor 30 and a second end 64 coupled to the force emulator 40. The first end 62 may be formed as an end fastener pivotally securing the lever 60 to the rotor projection 32 of the rotor 30 that is spaced from the axis hub 34. The second end 64 may be dimensioned to fit between the prongs 56, 58 of the force emulator 40. The lever 60 may be an elongate member.

The pedal assembly 20 includes a first friction device 66 pivotally secured to the lever 60 by a fastener 68 (e.g., bolt and nut, pivot pin, clevis pin). The first friction device 66 includes a friction surface 69. The friction surface 69 is configured to engage the inner wall 38. The friction surface 69 is disposed to contact the contact portion 39 of the inner wall 38 of the pedal base 36 in surface-to-surface contact. In one example, the first surface 37 and/or the friction surface 69 are planar surfaces. Thus, the friction (planar) surface 69 of the first friction device 66 is disposed to contact the first (planar) surface 37 of the inner wall 38 of the pedal base 36 in surface-to-surface contact. In the example the planar surfaces are substantially flat. While the inner wall 38 is shown in contact with the first friction device 66, other contact layers or materials having a contact surface secured to the inner wall 38 for contacting the surface of the first friction device 66 are also contemplated.

In one example the pedal assembly 20 includes one or more sensors. A force sensor 70 for determining an amount of force applied to the pedal pad 26 may be disposed in the pedal pad 26. Other force sensors can be mounted at other locations in other arrangements. A position sensor 80 for determining a position of the rotor 30 may be provided proximate the rotor 30 on the pedal base 36. The position sensor 80 may be disposed adjacent the rotor 30 for detecting rotation of the rotor 30 corresponding to movement of the pedal arm 24. In one example, the position sensor 80 is an inductive position sensor. The inductive position sensor may be disposed onto or adjacent the rotor 30. The inductive positions sensor and an inductive sensor target (not shown) are disclosed in detail in commonly owned U.S. patent application Ser. No. 18/047,174 filed Oct. 17, 2022, the disclosure of which is hereby incorporated by reference in its entirety. The inductive sensor target is typically a metal target. Additional positions sensors are contemplated in other examples.

In another example, the position sensor 80 is a Hall Effect sensor that determines a position of one or more magnets 86 disposed on the rotor 30. While one position sensor 80 is illustrated, additional positions sensors are contemplated in other examples. Further, a single or multiple magnets 86 are contemplated. It is further contemplated that the position sensor 80 is a combination of an inductive sensor and a magnet sensor, such as a Hall effect sensor.

In one example an electronic processor 84 is communicatively connected to the position sensor 80. The electronic processor 84 is configured to receive a position of the rotor 30 to determine an amount of braking force or acceleration for the vehicle pedal assembly 20. In other examples, the force sensor 70 provides a force output received as an input at the electronic processor 84. In another example, both a force sensor output and a position sensor output are combined to control the brake system or the acceleration system.

The pedal arm 24 and the rotor 30 of FIG. 1 are illustrated as a single integral element. Such an example is contemplated. In other examples, the pedal arm 24 is fixedly joined to the rotor 30.

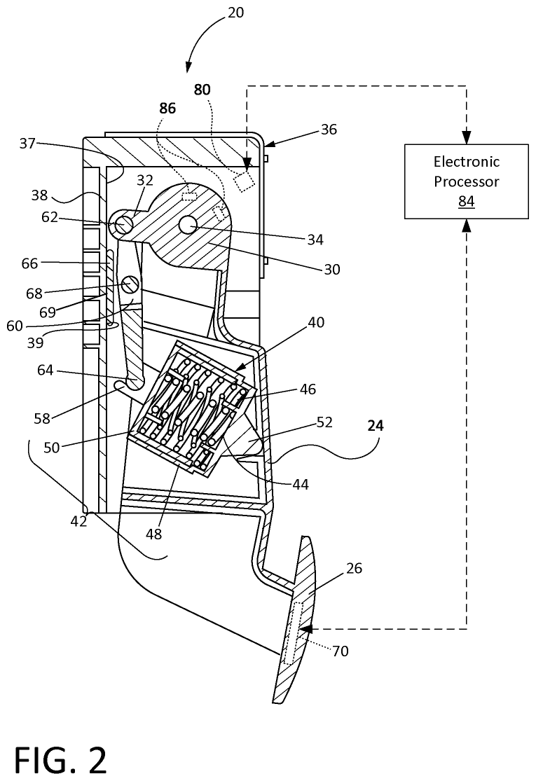

FIG. 2 illustrates the pedal assembly 20 with the pedal arm in a second position during operation. Application of a force to the pedal pad 26 causes rotation of the pedal arm 24 about the axis hub 34 of the rotor 30. Resistance to the movement of the pedal arm 24 is provided by the force emulator 40 and the first friction device 66 in surface-to-surface contact with the inner wall 38. The first spring 44 within the telescoping first and second housing sections 48, 50 provides a first resistance to movement of the pedal arm 24 and the second spring 46 provides a second resistance. As force is applied, the first and second springs 44, 46 are compressed as the second housing section 50 telescopes and moves within the first housing section 48.

At the same time, rotation of the rotor 30 causes an upward movement of the rotor projection 32. The upward movement of the rotor projection 32 causes substantially upward movement of the lever 60 and the first friction device 66 attached thereto. The first friction device 66 moves upwardly having a friction material in surface-to-surface contact with the inner wall 38 of the pedal base 36. The rotor 30 rotates in response to movement of the pedal arm 24.

At the same time, the second end 64 of the lever 60 is contained within the prongs 56, 58 of the force emulator 40. Thus, the force emulator 40 maintains force to stabilize the position of the lever 60. Further, the first friction device 66 is pivotally connected by the fastener 68 to the lever 60. The pivoting of the fastener 68 allows the first friction device 66 to maintain surface to surface contact with the inner wall 38 during upward movement thereof.

Mounting the first friction device 66 upwardly toward the first end 62 of the lever 60 increases friction during movement caused by application of force to the pedal arm 24. Alternatively, initial mounting of the first friction device 66 downwardly toward the second end 64 of the lever 60 decreases friction during movement caused by application of force to the pedal arm 24.

Operation of the pedal pad 26 also enables the position sensor 80 to sense rotation of the rotor 30. The electronic processor 84 processes the sensor outputs and controls a brake system or an acceleration system as a result of the sensed signals. In another example, both a force sensor output and a position sensor output are combined to control the brake system or the acceleration system.

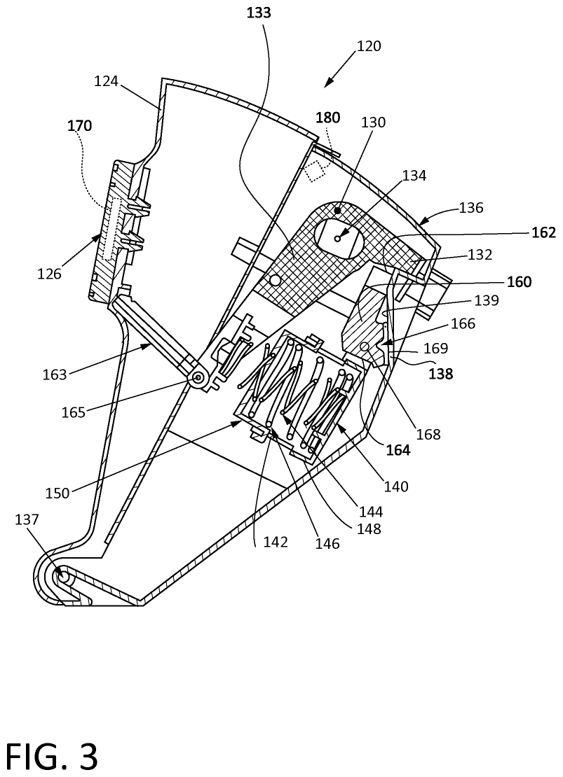

FIG. 3 illustrates a pedal assembly 120 with a second friction device 166 according to another example. In the illustrated example, the pedal assembly 120 includes a pedal arm 124 that supports a pedal pad 126. The pedal arm 124 connects with a rotor 130 that rotates about an axis hub 134 during rotation of the pedal arm 124. A pedal base 136 is configured to receive the rotor 130 and the pedal arm 124. The pedal base 136 may be formed as a housing having an inner wall 138 with a contact portion 139 facing the pedal arm 124. The rotor 130 may include a first rotor projection 132 extending in a general direction from the axis hub 134 toward the inner wall 138.

In the illustrated example the pedal arm 124 is joined with the pedal base 136 at a hinge 137. The rotor 130 may include a second rotor projection 133 extending in a general direction from the axis hub 134 toward the hinge 137. The pedal arm 124 is configured to pivot about the hinge 137 toward the pedal base 136. By way of example, the pedal base 136 is nested within the pedal arm 124 when a force is exerted on the pedal pad 126. In other words, when depressed the pedal arm 124 moves to envelop the pedal base 136.

The pedal assembly 120 includes a force emulator 140. The force emulator 140 may include a housing 142 having a first spring 144 and a second spring 146 disposed therein. In one example the first spring 144 telescopes within the second spring 146. The housing 142 may include a first housing section 148 and a second housing section 150 that telescopes within the first housing section 148.

The pedal assembly may include a link arm 163 extending between the pedal arm 124 and the pedal base 136. The link arm 163 may be pivotally connected by a link fastener 165 to an end of the second rotor projection 133 of the rotor 130. The other end of the link arm 163 may be disposed with the pedal arm 124 proximate the pedal pad 126.

The pedal assembly 120 includes a lever 160 having a first end 162 in communication with the rotor 130 and a second end 164 in communication with the force emulator 140. In some examples the lever 160 is directly coupled to the rotor 130 and/or the force emulator 140. It is also contemplated that the lever 160 is indirectly coupled to the rotor 130 and/or force emulator 140. Regardless of the connection, movement of the rotor 130 and/or the force emulator 140 is transferred to the lever 160.

The pedal assembly 120 includes a second friction device 166 pivotally secured to the lever 160 by a fastener 168 (e.g., bolt and nut, pivot pin, clevis pin). The second friction device 166 includes a friction surface 169. The friction surface 169 is disposed to contact the contact portion 139 of the inner wall 138 of the pedal base 136. In one example, the contact portion and/or the friction surface 169 include planar surfaces configured to come into contact-to-contact relationship. While the inner wall 138 is shown in contact with the second friction device 166, other contact layers or materials having a contact surface secured to the inner wall 138 for contacting the contact surface of the second friction device 166 are contemplated.

The pedal assembly 120 may include one or more sensors. In one example a force sensor 170 is disposed in the pedal pad 126. Other force sensors can be mounted at other locations in other arrangements. A position sensor 180 for determining a position of the rotor 130 may be provided proximate the rotor 130 on the pedal base 136. The position sensor 180 may be configured to provide a position of the rotor 130 to an electronic processor (e.g., the electronic processor 84) to determine an amount of braking force or acceleration for the pedal assembly 120. In one example, the position sensor 180 is an inductive position sensor (provided on the rotor 130). In another example, the position sensor 180 is a Hall Effect sensor disposed near the rotor 130 that determines the position of the rotor by monitoring a position of magnets (not shown) disposed on the rotor 130 as the rotor rotates. While one position sensor 180 is illustrated, additional positions sensors are contemplated in other examples. Further, a single or multiple magnets are contemplated.

During operation application of a force to the pedal pad 126 causes rotation of the pedal arm 124 about the hinge 137. The link arm 163 moves to rotate the rotor 130 about the axis hub 134 while resistance to the movement of the pedal arm 124 is provided by the force emulator 140. The first spring 144 within the telescoping first and second housing sections 148, 150 provides a first resistance to movement of the pedal arm 124 and the second spring 146 provides a second resistance. As force is applied, the first and second springs 144, 146 are compressed as the second housing section 150 telescopes and moves within the first housing section 148.

At the same time, rotation of the rotor 130 causes an upward movement of the rotor projection 132. The upward movement of the rotor projection 132 causes substantially upward movement of the lever 160 and the second friction device 166 attached thereto. The second friction device 166 moves upwardly having a friction material in surface-to-surface contact with the inner wall 138 of the pedal base 136.

Further, the second friction device 166 is pivotally connected by the fastener 168 to the lever 160. The pivoting about the fastener 168 allows the second friction device 166 to maintain surface to surface contact with contact portion 139 along the inner wall 138 during substantially upward movement thereof.

Operation of the pedal pad 126 also enables the position sensor 180 to sense rotation of the rotor 130. An electronic processor processes the sensor outputs and controls a brake system or an acceleration system as a result of the sensed signals. In another example, both a force sensor output and a position sensor output are combined to control the brake system or the acceleration system.

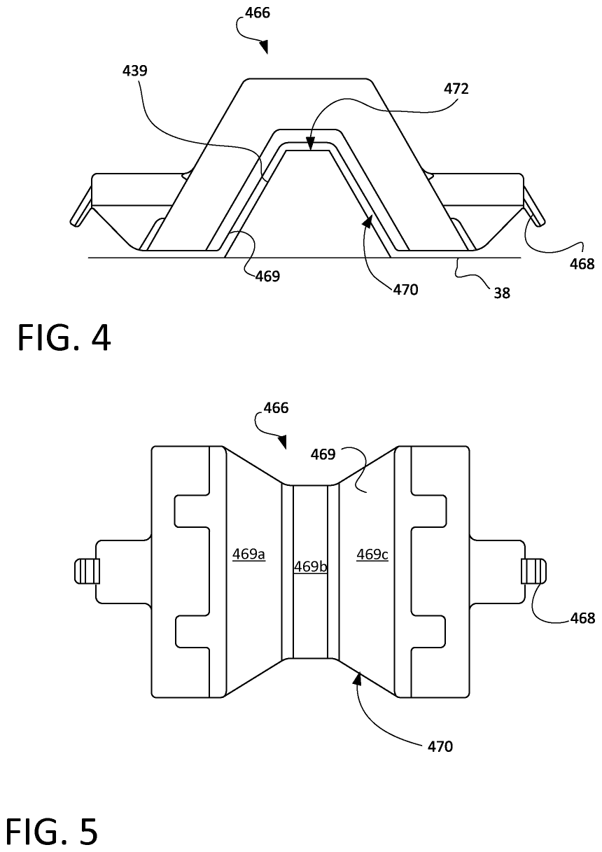

FIG. 4 illustrates a third friction device 466 according to one example. The third friction device 466 may be pivotally secured to a friction device lever (e.g., the lever 60 of FIG. 1). The third friction device 466 may include a fastener 468 (e.g., bolt and nut, pivot pin, clevis pin) for securing the third friction device 466 to the friction device lever.

The third friction device 466 may be include a recess 470. The recess 470 may be disposed on the lever 60 such that a friction surface 469 of the recess 470 may come into contact with a contact portion 439 of the inner wall 38. In one example, a protrusion 472 extends from the inner wall 38 to define the contact portion 439. The protrusion 472 may mirror the shape of the recess 470 such that at least a portion of the contact portion 439 is in surface-to-surface contact with the friction surface 469 of the recess 470. In one example the protrusion 472 may be formed separately from the inner wall 38 and secured to the inner wall 38 for contacting the friction surface 469 of the recess 470.

FIG. 5 illustrates a perspective view facing the recess 470 of the third friction device 466 from FIG. 4. In one example, the friction surface 469 of the recess 470 includes multiple planar surfaces 469a, 469b, 469c. Likewise, the contact portion 439 includes at least one planar surface for surface-to-surface contact therewith.

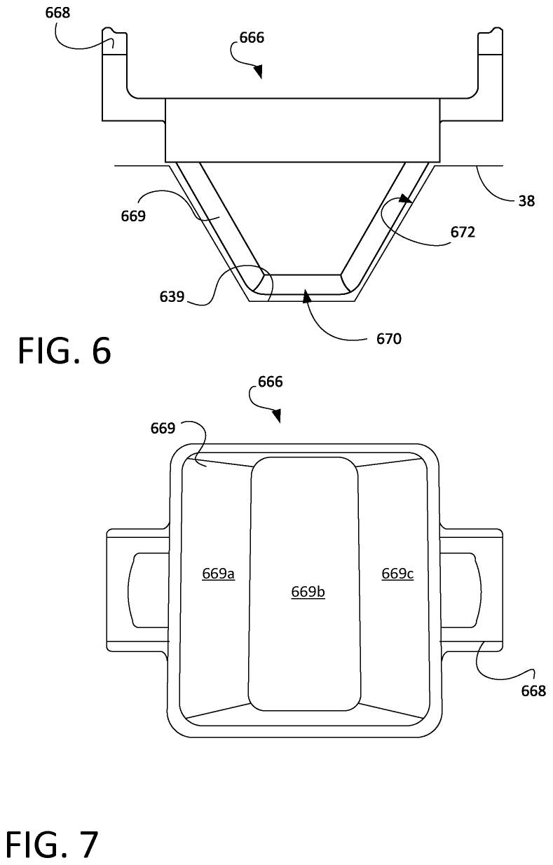

FIG. 6 illustrates a fourth friction device 666 according to one example. The fourth friction device 666 may be pivotally secured to the friction device lever (e.g., the lever 60 of FIG. 1). The fourth friction device 666 may include a fastener 668 (e.g., bolt and nut, pivot pin, clevis pin) for securing the fourth friction device 666 to the friction device lever.

The fourth friction device 666 may include a protrusion 670. The protrusion 670 may be disposed on the lever 60 such that a friction surface 669 of the protrusion 670 may come into contact with a contact portion 639 of the inner wall 38. In one example, a recess 672 extends into the inner wall 38 to define the contact portion 639. The recess 672 may mirror the shape of the protrusion 670 such that at least a portion of the contact portion 639 is in surface-to-surface contact with the friction surface 669 of the protrusion 670. In one example the recess 672 may be formed separately from the inner wall 38 and secured to the inner wall 38 for contacting the friction surface 669 of the protrusion 670.

FIG. 7 illustrates a perspective view facing the protrusion 670 of the fourth friction device 666 from FIG. 6. In one example, the friction surface 669 of the protrusion 670 includes multiple planar surfaces 669a, 669b, 669c. Likewise, the contact portion 639 includes at least one planar surface for surface-to-surface contact therewith.

The vehicle pedal assemblies 20, 120 described herein increase resistance as the pedal pads 26, 126 move further. When an operator releases the pedal pad 26, 126, the compressed spring 44, 144 of the force emulator 40, 140 generates a return force, restoring the pedal pad 26, 126 to an original position. Due to internal friction, the force experience by a vehicle operator during pedal application differs from the force during its return for the same amount of rotation. This characteristic is known as hysteresis.

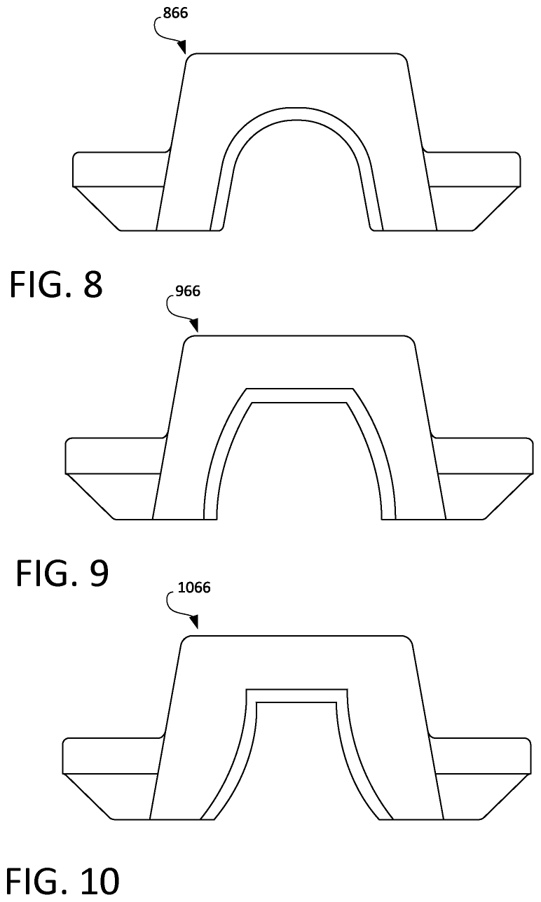

FIG. 8 illustrates a fifth friction device 866. The fifth friction device 866 may be pivotally secured to a friction device lever (e.g., the lever 60 of FIG. 1).

FIG. 9 illustrates a sixth friction device 966. The sixth friction device 966 may be pivotally secured to a friction device lever (e.g., the lever 60 of FIG. 1).

FIG. 10 illustrates a seventh friction device 1066. The seventh friction device 1066 may be pivotally secured to a friction device lever (e.g., the lever 60 of FIG. 1).

The fifth, sixth, and seventh friction devices 866, 966, 1066 may include similar features as the other friction devices described previously herein. It should be understood that the friction surface associated with the various friction devices described herein may be a curved friction surface or a planar friction surface as long as they provide the surface-to-surface contact with the contact portion associated with the inner wall 38. Additionally while the friction devices are illustrated as having a recess in FIGS. 8, 9, and 10, a protrusion is also contemplated.

In the foregoing specification, specific examples have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In addition, unless the context of their usage unambiguously indicates otherwise, the articles “a” and “an” should not be interpreted as meaning “one” or “only one.” Rather these articles should be interpreted as meaning “at least one” or “one or more”.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

We claim:

1. A pedal assembly for a vehicle comprising:
a pedal arm;
a pedal base including a contact portion;
a rotor coupled to the pedal arm, the rotor rotating in response to movement of the pedal arm;
a force emulator extending between a first end and a second end, the first end coupled to the pedal arm;
a lever joined at a first end to the rotor and joined at a second end to the second end of the force emulator; and
a friction device mounted to the lever, the friction device including a friction surface configured to engage the contact portion for surface-to-surface contact;
wherein rotation of the rotor due to application of a force to the pedal arm moves the lever.

2. The pedal assembly of claim 1, wherein the lever is pivotally secured to the rotor.

3. The pedal assembly of claim 1, wherein the friction surface of the friction device is a planar friction surface.

4. The pedal assembly of claim 3, wherein the contact portion is a planar surface for surface-to-surface contact with the planar friction surface.

5. The pedal assembly of claim 1, wherein the friction surface of the friction device is a curved friction surface.

6. The pedal assembly of claim 1, wherein the friction device comprises a recess and the contact portion is a protrusion configured to engage the recess.

7. The pedal assembly of claim 6, wherein the friction surface is provided on the recess.

8. The pedal assembly of claim 1, wherein the friction device comprises a protrusion and the contact portion is a recess configured to receive the protrusion.

9. The pedal assembly of claim 6, wherein the friction surface is provided on the protrusion.

10. The pedal assembly of claim 1, wherein the lever is an elongate member with the first end pivotally secured to the rotor and the second end pivotally secured to the second end of the force emulator.

11. The pedal assembly of claim 1, wherein the friction device is pivotally secured to the lever so that during movement of the lever the friction device maintains contact with a surface of the contact portion.

12. The pedal assembly of claim 1, wherein the force emulator includes a spring.

13. The pedal assembly of claim 1, wherein the force emulator is pivotally secured to a first end of a link arm, and wherein a second end of the link arm is joined to the pedal arm.

14. The pedal assembly of claim 13, wherein the force emulator includes multiple springs.

15. The pedal assembly of claim 1, further comprising a position sensor for determining a position of the rotor.

16. The pedal assembly of claim 15, wherein the position sensor is disposed adjacent the rotor for detecting rotation of the rotor corresponding to movement of the pedal arm.

17. The pedal assembly of claim 15, wherein the position sensor is an inductive position sensor for determining a position of an inductive sensor target.

18. The pedal assembly of claim 15, wherein the position sensor is a Hall Effect sensor determining position of magnets.

19. The pedal assembly of claim 1, including a hinge that couples the pedal arm to the pedal base.

20. A pedal assembly for a vehicle comprising:
a pedal arm;
a pedal base including a contact portion;
a hinge coupling the pedal arm to the pedal base;
a rotor in communication with the pedal arm, the rotor rotating in response to movement of the pedal arm;
a force emulator extending between a first end and a second end, the first end in communication with the pedal arm;
a lever joined at a first end to the rotor and joined at a second end to the second end of the force emulator; and
a friction device mounted to the lever, the friction device including a friction surface configured to engage the contact portion for surface-to-surface contact;
wherein rotation of the rotor due to application of force to the pedal arm moves the lever.

21. The pedal assembly of claim 20, further comprising a link arm coupling the rotor to the pedal arm.

22. The pedal assembly of claim 21, wherein the rotor comprises a rotor projection and the link arm pivotally connects to the rotor at the rotor projection.

23. The pedal assembly of claim 20, wherein the friction device is pivotally secured to the lever, wherein during movement of the lever the friction device maintains contact with a surface of the contact portion.
